(19) United States
(12) Patent Application Publication
(10) Pub. No.: US 2005/0207285 A1
(43) Pub. Date: Sep. 22, 2005

(54) Watch

(76) Inventors: Nobukazu Omori, Chiba-shi (JP); Haruki Hiranuma, Chiba-shi (JP)

Correspondence Address: BRUCE L. ADAMS, ESQ., 31ST FLOOR, 50 BROADWAY, NEW YORK, NY, 10004, US

(21) Appl. No.: 11/086,854

(22) Filed: Mar. 21, 2005

(30) Foreign Application Priority Data
Mar. 22, 2004 (JP) 2004-082211

(51) Int. Cl. A61C 8/00; G04B 27/02; G04B 29/00

(52) U.S. Cl. 368/319

(57) ABSTRACT

To provide a watch which can assure a smooth rotation operation of a crown, and in which it is possible to improve a durability and a workability of a mesh part between a winding stem pipe and a crown, and a life of a tool working the mesh part. A wristwatch, in which a crown is thread-locked to a winding stem pipe having been attached to a case band and a seal packing seals between the winding stem pipe and the crown, is made a premise. It is characterized in that the seal packing is provided while interrupting an invasion path of dusts with respect to a mesh part where the winding stem pipe has been meshed with the crown.

### BACKGROUND OF THE INVENTION

1. Field of the Invention

The present invention relates to a watch possessing a structure retaining a crown so as not to be rotated carelessly.

2. Description of the Prior Art

In the watch such as diver's watch, in order that the crown is not rotated carelessly in its carrying time, there is adopted a structure which locks the crown by utilizing a thread mesh (this structure is referred to as thread lock in the present specification).

In the thread lock of the watch of this kind, a winding stem pipe is attached to a case band in which a timepiece movement has been built, and a male thread formed in an outer circumference of a case band outside protrusion part of the winding stem pipe is meshed with a female tread formed in an inner circumference of a crown main part of the crown fitted with the above case band outside protrusion part. By this, at a usual time, it is possible to lock the crown by screwing in the crown main part to the outer circumference of the case band outside protrusion part and, when operating the timepiece movement, it is possible to perform a crown operation which, after a mesh of the crown main part with respect to the male thread has been disengaged, rotates the winding stem disposed in an inner side of the winding stem pipe by pull-moving the crown. Further, in order that a water and the like don't penetrate into the case band through the winding stem pipe, the watch has a seal packing disposed between the winding stem pipe and a crown tube part, which has been inserted into the inner side of the winding stem pipe, of the crow. This seal packing is disposed in a case band inner side than a mesh part between the above female thread and the above male thread (for example, refer to Patent Documents 1 and 2).

<Patent Document 1>

Microfilm of Utility Model Application No. Hei-2-57175 (JP-UM-A-4-16394)<

Patent Document 2>

CD-ROM of Utility Model Application No. Hei-5-61093 (JP-UM-A-7-26792)

In the watches of the Patent Documents 1 and 2, since the mesh part between the male thread and the female thread is provided in an outer side, in other words, side opposite to the case band inner side, with the seal packing performing a waterproofness to an inside of the case band being made a boundary, in a case where a crown operation such as time setting is performed by pull-moving the crown, the mesh part becomes a state exposed to an outside of the timepiece. For this reason, in the crown operation in seashore and ground etc. where sand dusts and the like are many, there is a possibility that fine dusts such as sand dusts enter into the above mesh part. If the sand dusts and the like enter into the mesh part and are bitten, there are fears that the operation for rotating the crow becomes heavy, and that wears and injuries of the male thread and the female thread become hasty and thus a durability is impaired.

Further, in the watches of the Patent Documents 1 and 2, when working the female thread to the crown main part of the crown, since it is impossible to penetrate a tap that is a working tool for threading the female thread into the crown main part, an in-feed depth of the tap with respect to the crown main part is shallow. For this reason, a ratio of an incomplete thread part occupying the worked female thread is large and a complete thread part is short. Accordingly, it is unavoidable that the mesh with the male thread becomes short as well. Additionally, since the tap threading the female thread is thin in its thickness from a necessity to escape a crown axle part and weak in its strength, its life is short and there is a limit in increasing an accuracy of the female thread. Owing to such circumstances, there is a difficulty in improving the durability of the mesh part between the female thread of the crown and the male thread of the winding stem, so that its improvement is demanded.

An object of the present invention is to provide a watch which can assure a smooth rotation operation of the crown, and in which it is possible to improve the durability of the mesh part between the winding stem pipe and the crown.

### SUMMARY OF THE INVENTION

In order to solve the above problems, the present invention is a watch in which a crown meshing with a winding stem pipe having been attached to a case band is thread-locked and a seal packing seals between the winding stem pipe and the crown, and the seal packing is provided while interrupting an invasion path of dusts with respect to a mesh part between the winding stem pipe and the crown.

In this invention, when rotation-operating the crown by disengaging the thread lock and pull-moving the crown, since the mesh part is not exposed to the outside of the timepiece, by the seal packing it is possible to prevent the dusts such as sand dusts from entering into the mesh part.

Further, in order to solve the above problems, the present invention is a watch in which a crown meshing with a winding stem pipe having been attached to a case band is thread-locked and a seal packing seals between the winding stem pipe and the crown, and the winding stem pipe is meshed with the crown in a case band inner side with the seal packing being made a boundary.

In this invention, the case band inner side does not indicate an inside of the case band, in which the timepiece movement has been accommodated, but does indicate a direction fronting from the seal packing toward the above inside of the case band. For this reason, in this invention, a portion (mesh part) where the winding stem pipe has been meshed with the crown is provided in a region between the inside of the case band, in which the timepiece movement has been accommodated, and the seal packing, and the seal packing interrupts the invasion path of dusts with respect to the above mesh part.

In this invention, since the portion (mesh part) where the winding stem pipe has been meshed with the crown is provided in the case band inner side than the seal packing and the seal packing interrupts the invasion path of dusts with respect to the mesh part, when rotation-operating the crown by disengaging the tread lock and pull-moving the crown, there is no fact that the mesh part is exposed to the outside of the timepiece. For this reason, by the seal packing it is possible to prevent the dusts such as sand dusts from entering into the mesh part.

Further, in order to solve the above problems, in the present invention, a winding stem pipe having a female thread is attached to a case band, a crown having a crown tube part, in which a male thread meshing with the female thread has been formed, is movably attached to the winding stem, and a seal packing which seals between the winding stem pipe and the crown is interposed between the winding stem pipe and the crown in a side opposite to a case band inner side with a mesh part between the female thread and the male thread being made a boundary.

In this invention, since the seal packing interrupts the invasion path of dusts with respect to the mesh part between the female thread of the winding stem pipe and the male thread of the crown tube part that the crown has, when rotation-operating the crown by disengaging the tread lock and pull-moving the crown, there is no fact that the mesh part is exposed to the outside of the timepiece. For this reason, by the seal packing it is possible to prevent the dusts such as sand dusts from entering into the mesh part. Additionally, in this invention, since the female thread has been provided in the winding stem pipe and the male thread has been provided in the crown tube part, a workability of the female thread and the male thread becomes good and thereby the accuracy of the thread can be improved, and the durability of the mesh part can be improved as complete thread parts of the female thread and the male thread can be formed lengthily.

Further, in a preferred mode of the present invention, the winding stem pipe has an inner circumference face whose diameter is larger than a valley diameter of the female thread in a side opposite to a case band inner side with a mesh part between the female thread and the male thread being made a boundary, a crown tube part of the crown has an outer circumference face whose diameter is larger than a ridge diameter of the male thread and which is opposed to the inner circumference face, and the seal packing is disposed between the inner circumference face and the outer circumference face. In this mode of the invention, since a spiral flaw generated as the female thread or the male thread is worked is not formed in the above inner circumference face or the above outer circumference face, that becomes a seal face with which the seal packing closely contact, it is excellent in a point that a high seal performance can be developed.

Further, in a preferred mode of the present invention, an inner side seal packing which seals between the winding stem pipe and a crown tube part of the crown is provided in a side opposite to the seal packing with a mesh part between the female thread and the male thread being made a boundary. In this mode of the invention, it is excellent in a point that wear particles generated in the mesh part between the female thread and the male thread with the crown operation can be suppressed by the inner side seal packing from entering into the inside of the case band in which the timepiece movement is accommodated.

### BRIEF DESCRIPTION OF THE SEVERAL VIEWS OF THE DRAWINGS

A preferred form of the present invention is illustrated in the accompanying drawings in which:

FIG. 1 is a front view showing a watch concerning a 1st embodiment of the present invention;

FIG. 2 is a sectional view showing along an F2-F2 line in FIG. 1 under a state that a crown has been thread-locked; and

FIG. 3 is a sectional view corresponding to FIG. 2, which shows a watch concerning a 2nd embodiment of the present invention under the state that the crown has been thread-locked.

### DETAILED DESCRIPTION OF THE PREFERRED EMBODIMENTS

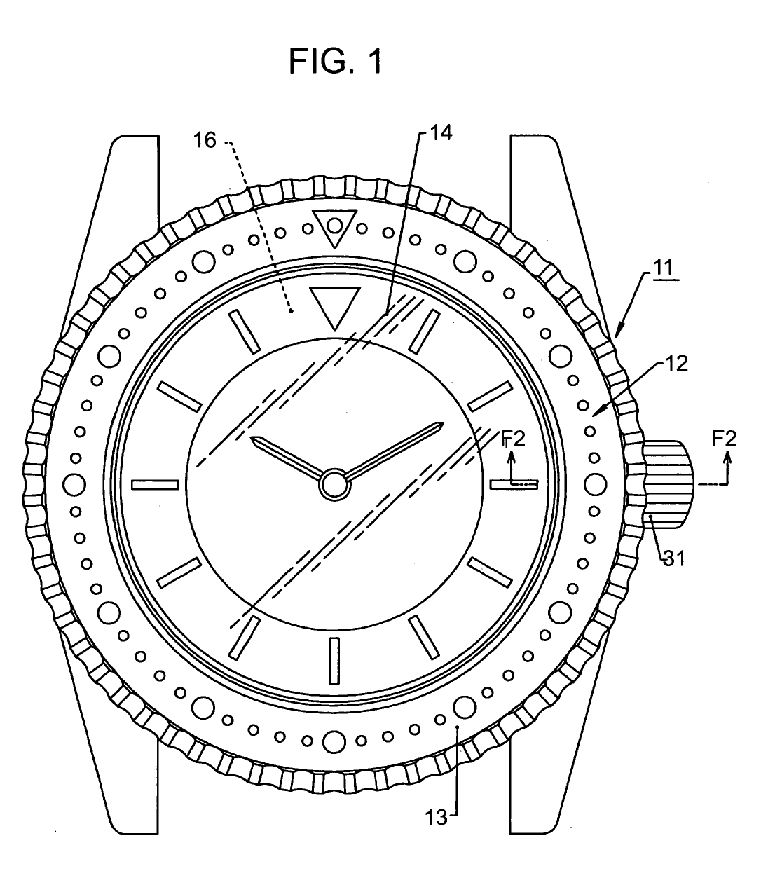

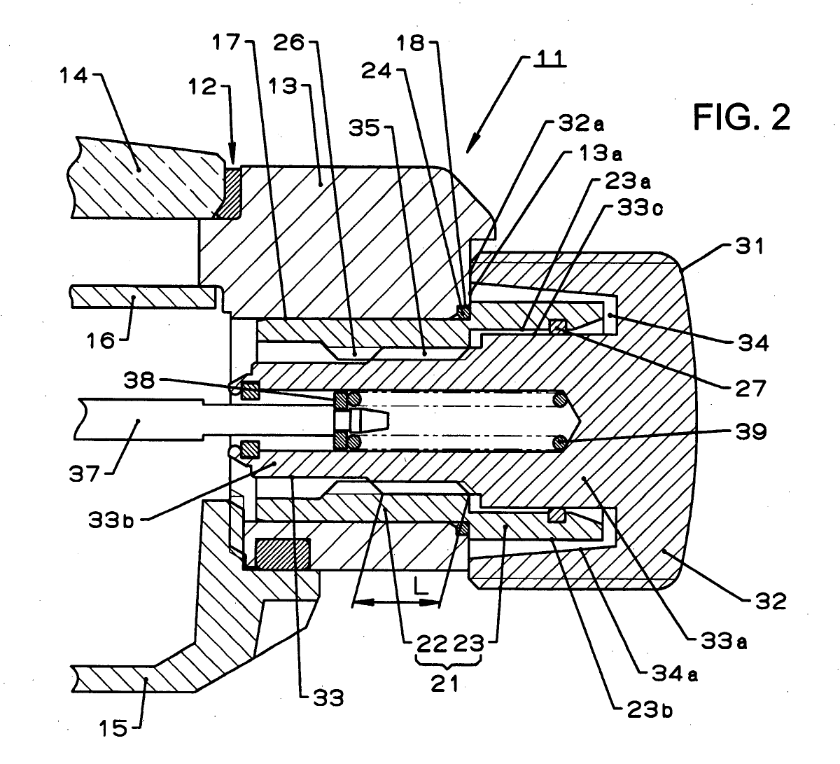

A 1st embodiment of the present invention is explained by referring to FIG. 1 and FIG. 2.

In FIG. 1, a reference numeral 11 denotes a wristwatch as a watch possessing a structure capable of thread-locking a crown. This wrist watch 11 accommodates in its time piece armor assembly 12 a timepiece movement not shown in the drawing, and the like. The timepiece movement may be any of one in which a small battery or a main spring has been made a power, or automatic winding one, or one corresponding to a digital timepiece digital-displaying a time and the like on a dial by a quartz oscillation module, or one in which one corresponding to the digital timepiece and one other than the former have been used in combination, or the like.

The timepiece armor assembly 12 is formed by liquid-tightly mounting a cover glass 14 to one face of an annular metal-made case band 13 in its thickness direction, and liquid-tightly mounting a case back 15 to a back face of the case band 13 in its thickness direction. It is possible to see a dial 16 and the like through the cover glass 14, and the case back 15 is detachable.

As shown in FIG. 2, in one part of the case band 13, there is perforated a pipe attachment hole 17 penetrating through this case band 13 in its radial direction. One end of the pipe attachment hole 17 is opened inside the case band, i.e., to an inside of the timepiece armor assembly 12, and the other end of the pipe attachment hole 17 is opened outside the case band, i.e., to an outside of the timepiece armor assembly 12. An annular accommodation groove 18 is formed in a case band outer face 13a of the case band 13. This accommodation grove 18 is larger in its diameter than the pipe attachment hole 17, communicates with a case band outer side opening of this hole 17, and is provided concentrically with this opening.

A winding stem 21 having been inserted from the case band outer side into the pipe attachment hole 17 is water-lightly fixed to the case band 13.

Detailedly, the winding stem pipe 21 is made of a metal and, for example, a stainless steel can be suitably used. The winding stem pipe 21 has an insertion part 22 in one end side and a case band outside protrusion part 23 in the other end side, which is contiguous to the insertion part 22 while forming a step. The insertion part 22 is a portion inserted into the pipe attachment hole 17 from the case band outer side under a slightly pressed state. The case band outside protrusion part 23 is a portion disposed outside the case band 13. An outer diameter of this case band outside protrusion part 23 is larger than an outer diameter of the insertion part 22 and a diameter of the accommodation groove 18. An inner diameter of the case band outside protrusion part 23 is larger than an inner diameter of the insertion part 22.

This winding stem 21 is inserted into the pipe attachment hole 17 till the case band outside protrusion part 23 butts against the case band outer face 13a, and fixed to the case band 13 so as not capable of separating from it by a metal-made brazing filler material 24 filled in the accommodation groove 18. The brazing filler material 24 bearing this fixation functions also as a member bearing the waterproofness between the case band 13 and the winding stem pipe 21. Incidentally, in the present embodiment, the insertion part 22 is a length not penetrating through the pipe attachment hole 17, but it may be made a length penetrating through the attachment hole 17.

In an inner face of the insertion part 22, there is formed a female thread 26 for a thread lock. A diameter of an inner circumference face 23a of the case band outside protrusion part 23 is larger than a valley diameter of the female thread 26. An outer side seal packing 27 consisting of a rubber and the like is attached to an annular packing attachment groove formed in this inner circumference face 23a.

A crown denoted by a reference numeral 31 in FIG. 1 is made of a metal and, as shown in FIG. 2, has a crown main part 32 and a crown tube part 33 monolithically protruding in a back side from a center part of the former.

In the crown main part 32, there is provided an annular groove 34 surrounding a root side portion 33a of the crown tube part 33. This annular groove 34 is a portion into which the case band outside protrusion part 23 of the winding stem pipe 21 is loosely inserted. The crown tube part 33 is formed from the root side portion 33a, and a tube tip side portion 33b that is a portion other than this root side portion 33a.

The tube tip side portion 33b of the crown tube part 33 is a portion disposed while being inserted into an inner side of the insertion part 22. In an outer circumference face of this tube tip side portion 33b, there is formed a male thread 35 for the thread lock. The male thread 35 is detachably meshed with the female thread 26 of the winding stem pipe 21. By this mesh, the crown 31 can be thread-locked so as not to be rotated carelessly at a carrying time of the wristwatch 11. That is, the above mesh can be obtained by applying fingers to the crown main part 32 and rotating the crown 31 in its clamping direction, and can be disengaged by rotating the crown 31 in its loosening direction reversely to the former direction. By clamping the crown 31 by rotating it, as shown in FIG. 2, a backside end face 32a of the crown main part 32 closely contacts with the case band outer face 13a of the case band 13 and thus the crown 31 is thread-locked.

The root side portion 33a of the crown tube part 33 is a portion disposed while being inserted into an inner side of the case band outside protrusion part 23. This root side portion 33a is larger in its diameter than a ridge diameter of the male thread 35 and the above valley diameter of the female thread 26, and its outer circumference face 33c is opposed to the above inner circumference face 23a. This outer circumference face 33c is smooth, and functions as a seal face.

The crown tube part 33 is screwed from the case band outer side into the winding stem pipe 21, and provided so as to be capable of progressing or regressing in its axial direction. In other words, it is attached under a meshed state by meshing the male thread 35 with the female thread 26.

A mutual relation between the crown tube part 33 and the winding stem pipe 21 into which the former has been inserted under this state is shown in FIG. 2. In other words, the tube tip side portion 33b of the crown tube part 33 is inserted into the insertion part 22 of the winding stem pipe 21 and thus the male thread 35 is meshed with the female thread 26, the root side portion 33a of the crown tube part 33 is inserted into the case band outside protrusion part 23 of the winding stem pipe 21, and this root side portion 33a is inserted into the annular groove 34 of the crown main part 32.

In this mutual relation, on the occasion of a crown operation, an interstice formed between the crown main part 32 and the case band outer face 13a of the case band 13 and an interstice which is contiguous to the former interstice and has been formed between the annular groove 34 and the case band outside protrusion part 23 become an invasion path of the water and the like with respect to the mesh part between the male thread 35 and the female thread 26. The seal packing 27 is disposed in this invasion path. Concretely in the present embodiment, the seal packing 27 is provided in the invasion path while interrupting an interstice between the inner circumference face 23a of the case band outside protrusion part 23 and the outer circumference face 33c of the root side portion 33a. This seal packing 27 is interposed between the inner circumference face 23a and the outer circumference face 33c while being elastically deformed to a compressed state, and bears the waterproofness between these faces. Incidentally, the seal packing 27 may be closely contacted with the inner circumference face 23a by being attached to the outer circumference face 33c. With respect to the seal packing 27 of the above disposition, the above mesh part is provided while adjoining an inside of the case band 13 than the seal packing 27, in other words, in a case band inner side with the seal packing 27 being made a boundary.

Incidentally, it is also possible to interrupt the invasion path by disposing the seal packing 27 between an outer circumference face 23b of the case band outside protrusion part 23 and an inner circumference face 34a of the annular groove 34 instead of the above disposition. Also in this case, the seal packing 27 can, by being supported by one of the outer circumference face 23b and the inner circumference face 34a, be closely contacted with the other. Incidentally, in comparison with this disposition, the fact that the seal packing 27 is disposed in such a manner as shown in FIG. 2 is desirable in a point that the seal packing of low cost can be used because it is small, and a frictional resistance by the seal packing when rotation-operating the crown 31 is small and so the crown operation can be lightened.

As shown in FIG. 2, within the crown tube part 33, a winding stem 37 of the timepiece movement is inserted from a case band inside, and a coil spring 39 biasing this winding stem 37 in its axial direction through a spring bridge 38 is accommodated. The timepiece movement is rotated while interlocking with the rotation operation of the crown 31 under a state that the mesh of the male thread 35 with respect to the female thread 26 has been disengaged, in other words, under a state that the thread lock has been released. It is adapted such that, by this, the time setting and the like are performed.

Under a usual state of the wristwatch 11 possessing the above constitution, the crown 31 is being clamped, and the male thread 35 of its crown tube part 33 meshes with the female thread 26 of the winding stem 21, so that it is being thread-locked. For this reason, it is possible to prevent a time display and the like from changing by the fact that the crown 31 is rotated carelessly during a carriage.

In a case where the time setting and the like are performed, it is possible to perform them under a state that the crown 31 has been pulled out while resisting against a spring force of the coil spring 39 by disengaging the mesh of the male thread 35 of the crown main part 32 with respect to the female thread 26 (by releasing the thread lock) by reversely rotating the crown 31.

Under this release state of the lock, since the invasion path with respect to the mesh part becomes a state communicating with the outside of the timepiece, when performing the time setting in a place, such as seashore for instance, where the sand dusts are many, there is the fact that the fine dust such as sand dusts enter into the invasion path. However, since the invasion path of the dusts with respect to the mesh part is interrupted in its midway by the seal packing 27, there is no fact that the mesh part is exposed to the outside of the timepiece, so that it is possible to prevent the dusts and the like from reaching the mesh part and being bitten.

By this, such fears are solved that the crown operation becomes heavy when rotating the crown 31 in its clamping direction in order to perform the thread lock after the time setting and the like have been performed and thereafter, and that the wears and the injuries of the male thread 35 and the female thread 26 become hasty and thus the durability is impaired, and the crown operation can be performed lightly. Moreover, since the invasion of the water into the mesh part is also interrupted by the seal packing 27, even in a case where the crown operation is not performed for a long period, it is also possible to prevent the rotation operation of the crown 31 from becoming heavy with a product, in the mesh part, due to a reaction with the water being made a cause.

Further, the female thread 26 for the thread lock is formed not in the crown 31 but in the inner circumference of the winding stem pipe 21. For this reason, for the tap that is the working tool for threading the female thread 26, it is possible to use one whose thickness is approximately equal to an inner diameter of the insertion part 22 of the winding stem pipe 21 and, by this as a mechanical strength of the tap is increased, its life can be improved. Additionally, since the tap can thread the female thread 26 by being inserted through the winding stem 21 without its working feed being limited to a short distance, a workability of the male thread 26 is good. For these reasons, it is possible to reduce a working cost of the female thread 26. Incidentally, since the male thread 35 for the thread lock can be threaded by a cutting tool not in the winding stem pipe 21 but in the outer circumference of the tube tip side portion 33b of the crown tube part 33 and thus this working can be performed in a working space opened to the outer side, its workability is good.

Moreover, since the root side portion 33a is larger in its diameter than the tube tip side portion 33b, there is no fact that the cutting tool is moved while contacting with the outer circumference face 33c of this root side portion 33a. For this reason, there is no fact that a surface of the outer circumference face 33c, of the root side portion 33a, with which the seal packing 27 pressure-contacts is roughened with the working of the male thread 35. Accordingly, the waterproofness and the dustproofness by the seal packing 27 can be surely assured.

Additionally, as already mentioned, since the female thread 26 is formed by inserting the tap through the insertion part 22, the female thread 26 can be formed lengthily within a length range of the insertion part 22, so that it is possible to provide its complete thread part lengthily and moreover accurately. Together with this, also as to the male thread 35, it is possible to provide the male thread 35 lengthily and moreover accurately within a length range of the tube tip side portion 33b of the crown tube part 33. And, since the female thread 26 has been meshed with the male thread 35, a length (denoted by a sign L in FIG. 2) of the mesh part where the complete thread parts mesh each other under the thread lock state can be ensured lengthily. By this, it is possible to improve the durability of the mesh part under the thread lock state.

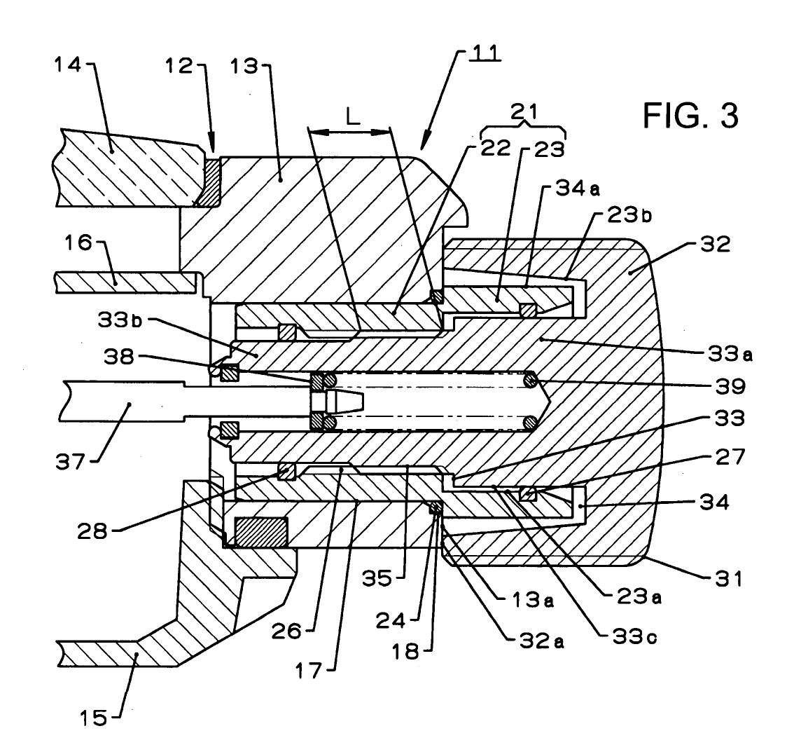

FIG. 3 shows a 2nd embodiment of the present invention. Since this embodiment is basically the same as the 1st embodiment, as to the same constitution as the 1st embodiment, the same reference number is applied and its explanation is omitted, and hereunder a constitution different from the 1st embodiment and its action are explained.

In the 2nd embodiment, an inner side seal packing 28 sealing between the inner circumference face of the insertion part 22 of the winding stem pipe 21 and the outer circumference face of the tube tip side portion 33b of the crown tube part 33 is attached while approaching an inside side of the case band 13 than the mesh part between the female thread 26 and the male thread 35. This seal packing 28 is supported in the inner circumference face of the insertion part 22 for instance and closely contacted with the outer circumference face of the tube tip side portion 33b, but instead of this it is also possible that it is supported in the outer circumference face of the tube tip side portion 33b and closely contacted with the inner circumference face of the insertion part 22.

The constitutions other than that explained above are the same as the 1st embodiment. Accordingly, also in this 2nd embodiment, the problems of the present invention can be solved. Moreover, by the fact that the inner side seal packing 28 has been provided, itis excellent in a point that the wear particles generated by the wear in the mesh part between the female thread 26 and the male thread 36 can be suppressed from entering into the inside of the case band 13 in which the timepiece movement is accommodated.

The present invention is not limited to each of the above embodiments. For example, besides the present invention can be suitably applied to the diver's watch for which a high pressure waterproof performance is demanded, it can be applied also to the watch, such as wristwatch and pocket watch, for which such a high pressure waterproof performance is not demanded.

According to the present invention, since the invasion of the dusts into the mesh part between the winding stem pipe and the crown can be prevented, it is possible to provide a watch in which a smooth rotation operation of the crown is assured, and the durability of the mesh part is improved as well.

1. A watch comprising:
a crown meshing with a winding stem pipe having been attached to a case band to be thread-locked and
a seal packing seals between the winding stem pipe and the crown,
wherein the seal packing is provided while interrupting an invasion path of dusts with respect to a mesh part between the winding stem pipe and the crown.

2. A watch comprising:
a crown meshing with a winding stem pipe having been attached to a case band to be thread-locked and
a seal packing seals between the winding stem pipe and the crown,
wherein the winding stem pipe has been meshed with the crown in a case band inner side with the seal packing being made a boundary.

3. A watch comprising:
a case band,
a winding stem pipe having a female thread and having been attached to the case band,
a crown having a crown tube part, in which a male thread meshing with the female thread has been formed, and having been movably attached to the winding stem pipe, and
a seal packing which is interposed between the winding stem pipe and the crown in a side opposite to a case band inner side with a mesh part between the female thread and the male thread being made a boundary, and which seals between the winding stem pipe and the crown.

4. A watch according to claim 1, wherein the winding stem pipe has an inner circumference face whose diameter is larger than a valley diameter of the female thread in a side opposite to a case band inner side with a mesh part between the female thread and the male thread being made a boundary, a crown tube part of the crown has an outer circumference face whose diameter is larger than a ridge diameter of the male thread and which is opposed to the inner circumference face, and the seal packing is disposed between the inner circumference face and the outer circumference face.

5. A watch according to claim 2, wherein the winding stem pipe has an inner circumference face whose diameter is larger than a valley diameter of the female thread in a side opposite to a case band inner side with a mesh part between the female thread and the male thread being made a boundary, a crown tube part of the crown has an outer circumference face whose diameter is larger than a ridge diameter of the male thread and which is opposed to the inner circumference face, and the seal packing is disposed between the inner circumference face and the outer circumference face.

6. A watch according to claim 3, wherein the winding stem pipe has an inner circumference face whose diameter is larger than a valley diameter of the female thread in a side opposite to a case band inner side with a mesh part between the female thread and the male thread being made a boundary, a crown tube part of the crown has an outer circumference face whose diameter is larger than a ridge diameter of the male thread and which is opposed to the inner circumference face, and the seal packing is disposed between the inner circumference face and the outer circumference face.

7. A watch according to claim 1, wherein an inner side seal packing which seals between the winding stem pipe and a crown tube part of the crown is provided in a side opposite to the seal packing with a mesh part between the female thread and the male thread being made a boundary.

8. A watch according to claim 2, wherein an inner side seal packing which seals between the winding stem pipe and a crown tube part of the crown is provided in a side opposite to the seal packing with a mesh part between the female thread and the male thread being made a boundary.

9. A watch according to claim 3, wherein an inner side seal packing which seals between the winding stem pipe and a crown tube part of the crown is provided in a side opposite to the seal packing with a mesh part between the female thread and the male thread being made a boundary.
